(19) United States
(12) Patent Application Publication
(10) Pub. No.: US 2001/0054180 A1
(43) Pub. Date: Dec. 20, 2001

(54) System and method for synchronizing output of media in public spaces

(76) Inventor: Paul D. Atkinson, Carlsbad, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/757,087

(22) Filed: Jan. 8, 2001

Related U.S. Application Data
(60) Provisional application No. 60/174,982, filed on Jan. 6, 2000.
(60) Provisional application No. 60/175,124, filed on Jan. 6, 2000.
(60) Provisional application No. 60/175,123, filed on Jan. 6, 2000.
(60) Provisional application No. 60/175,125, filed on Jan. 6, 2000.

(51) Int. Cl. H04N 7/025; H04N 7/10

(52) U.S. Cl. 725/32

(57) ABSTRACT

A system, method and apparatus for synchronizing output of media in a public space. Different types of media elements, related to one another, are output at related times to different devices within a public space. The timing may be adjusted over a wide range, or a narrow range, to handle a wide range of needs. General programming media elements are selected for output in a public space based upon a source indicating available media elements, and upon transient variables especially pertinent to the public space, which are provided independently of user inputs. Metadata media related to but distinct from an output programming media element may be independently selected for output to different devices, via different signal paths and protocols.

This application claims the benefit under 35 USC § 119(e) of the following provisional applications filed Jan. 6, 2000: U.S. Ser. No. 60/174,982 “System and Method of Controlling the Output of Media in Public Spaces;” U.S. Ser. No. 60/175,124 “System and Method of Synchronized Delivery of Media to Users in Public Spaces;” U.S. Ser. No. 60/175,123 “System and Method of Integrating Local Information and Broadcast Media for Delivery Into Personal, Wireless Devices;” and U.S. Ser. No. 60/175,125 “System and Method of Executing Electronic Transactions in Public Spaces”.

### FIELD OF THE INVENTION

This application relates to the field of communication, and includes aspects of electronic commercial communications, bidirectional interactive communications, and unidirectional communication to receiving devices.

### BACKGROUND

In public spaces the primary methods of distributing electronic media are television, video (tape/VCR or CD/DVD) and radio/music (broadcast, tape, CD etc.). Interactive media is limited primarily to specialty kiosks, proprietary games and Internet terminals. There is a need for a substantial expansion of the interactive aspects of media in public places. Because of the limitations of the existing methods and systems of distribution in individual public spaces consumers are not provided with media, such as video and audio, that is targeted to the frequently changing demographics, conditions and characteristics of specific locations. For example, present methods and systems do not readily provide for frequently varying demographics at each store in a chain with 300 locations. Similarly absent is media which changes in response to frequent changes in the conditions and characteristics of specific locations (such as demographics, local weather, or inventory levels at each location, or music playing on the local jukebox). There is no well-defined way to provide coordinated/synchronized delivery of different types of media to different types of devices (e.g. deliver to a Palm Pilot™ information about the song ‘now playing’—artist, title, CD upcoming concert tour, etc.—while the song is playing on speakers and/or the music video is playing on TV.) Also missing is a method of using a handheld device to purchase products that are promoted by media delivered within the same public spaces, such as using a Palm Pilot™ to purchase a CD with the song ‘now playing’ in a coffee shop. Similarly, there is no convenient method of receiving digital products (for example MP3 song files) on a personal device (for example a Palm Pilot™ or a web enabled cell phone) during a concert. Also omitted is a method of using personal handheld devices to extend the consumer/fan experience, such as to vote for the play of the day shown on TV in a sports bar, or on the Jumbotron in a stadium.

Accordingly, there exists a need for the foregoing services and features.

### SUMMARY OF THE INVENTION

The foregoing needs are addressed by combining various aspects of the inventive system and methods described herein. In particular, these needs are addressed in part by providing for media to be presented through multiple output devices within a public space in a coordinated fashion, dependent upon local conditions. Different kinds of media (such as video, audio or HTML programming media elements, and any text or structured data) are accepted from multiple media sources, and a selection of them is broadcast or transmitted within a public space dependent on local conditions at any given time.

Metadata which is related to media presentations (programming media elements) taking place within a public space at a given time may be locally broadcast or transmitted to personal devices within the public space. Some of such metadata may provide the opportunity for the user to engage in transactions for the purchase of products or services referred to or embodied by these other programming media presentations. The output of related media to multiple devices is referred to herein as synchronization or synchronized delivery.

A Local Media Manager (LMM) device is employed to coordinate the foregoing activities. The LMM may include devices to obtain and store media elements, but conversely to a VCR or PVR (personal video recorder), the LMM controls the selection of media elements and the time and location to output the selected media elements. The Local Media Manager controls output using information from a Play List, and using locally relevant variables and logic in a Logic Controller. The Local Media Manager is generally operated for a public space by a remote system manager, or at least a manager who is independent from users within the public space to which the selected media elements are directed. Such users may at times input variables to the system which affect the LMM outputs, but they do not directly control the basic output of media elements as they would, for example, when selecting a particular channel or audio track using a remote control. Many variables which may be used by the Local Media Manager, including local environmental data such as temperature and weather, and other locally relevant variables such as population at the store and inventory levels, are entered independently of the user or users.

The Local Media Manager can simultaneously control multiple media outputs of varying lengths. For example, an audio track, such as a musical composition, may continue to be output longer than a series of independently scheduled video elements which may be associated with the audio track. The Local Media Manager can automatically change output, without human intervention, in response to variables other than date or time. For example, as the current temperature or level of inventory fluctuates in a particular public space or domain, the output automatically changes within that particular public space or domain. This approach contrasts with preprogrammed output based at most on a date/time schedule.

Decisions by the Local Media Manager may be based on single variables, such as local temperature, or on multiple variables, such as stock on hand in combination with temperature. The Local Media Manager can simultaneously support multiple classes of media (such as programming, metadata and local content), multiple media types (such as video, audio, data, web pages, etc.), and multiple media mediums or paths, such as cable and wire, infrared (IR), and local RF paths.

One aspect of the system and method described herein synchronizes media such as video, audio and data in integrated and interactive ways. The output of media is synchronized independently for each public space or domain. For example, an order form that includes local content such as an identity of the public space (e.g. LAX terminal 1) or other data related to the public space may be locally broadcast to personal devices such as Palm Pilots™ in synchronization with an advertisement being transmitted to a TV set in the airport lounge.

Simultaneous, time-delayed, time-advanced and extended transmissions and broadcasts may be synchronized within particular public spaces. For example, in a particular public place, product information related to a thirty-second TV advertisement may be synchronized to be locally broadcast continuously for an extended period of five minutes, starting time-delayed after the beginning of the televised advertisement. Such information (here, product information), related primarily to a programming media element in the public space (here, an advertisement output to a TV), will be called “metadata” throughout this application.

To maintain availability of the metadata (here, product information) well after the end of the output of the programming media element (here, an advertisement), it is useful to simultaneously broadcast metadata related to several different preceding programming media elements. Moreover, in order to facilitate access by a user to the metadata, it will be useful in many cases to transmit the product information to a device, such as the user's personal communication device, which is separate from the device to which the basic advertisement is output. Such a separate device may usefully have storage for the metadata for easy retention by the user. Any device to which the metadata is output, whether separate from the programming media element output device or not, may also benefit from features permitting the user to interact with the system, for example in order to request or give information or to initiate a purchase transaction.

Metadata transmissions to individual users, or broadcasts to many users, may be variably synchronized to programming media element outputs on the basis of variables which affect the metadata broadcast timing. For example, the metadata (product information) related to the programming media element (advertisement) described above may be broadcast for an extended time if inventory is high and/or sales are brisk, or the broadcast may be terminated if the advertised item is sold out. In other cases it will be advantageous to provide the metadata at least in part prior to the programming media element.

The output of programming media elements to output devices (for example, a video program output to a public-area monitor) may be synchronized with the output of both metadata related to the programming media elements (such as product information, order forms, or related reference material), and local content related to the public space in which the programming media element is output (such as an identity of the public space, the time of day, weather and number of users in the public space). The metadata and local content may be structured as web pages, data sheets, electronic menus, order forms, etc., and broadcast to wireless personal devices. The programming media elements, such as television shows, video loops, sound tracks, etc., will typically be broadcast or conveyed by cable to passive output devices which merely present the programming media element in the public space, and the metadata and local content will typically be broadcast at a related time but to separate interactive devices under the control of users, such as a notebook computer, a Pocket PC™ mobile device, or a local RF enabled cell phone. Wireless broadcasts using different communication media, such as IR vs. local RF, may be synchronized with each other within each particular public space.

However, the three information categories of programming media elements, metadata and local content may also be transmitted to the same output device within the public space. In this case it will be useful if the device receiving these outputs is interactive with one or more users. Examples of appropriate devices for receiving all three information categories include a personal digital assistant (PDA) connected to a wireless local area network, and an interactive television station at a kiosk which is connected to a wired Ethernet or other local area network.

Locally stored content may be synchronized with content received from outside the public space. For example, advertisements for specific types of shoes (programming) and order forms therefor (metadata) may be broadcast within stores via local RF to kiosks. This may be performed within a variety of stores, depending on an individual store's local stock, in synchronization first with programming such as an advertisement televised nationally on a sports program and output to TVs in stores throughout a retail chain.

The system presently described is designed to synchronously transmit or broadcast programming to passive output devices, while synchronously broadcasting or transmitting related programming, metadata and local content to a variety of different types of mobile devices, even those which may be in the possession of user or users in unknown quantities. Such mobile devices may be personal devices, such as Palm Pilots™ or local-RF equipped cell phones, which are brought into the public space by the user, or which may be rented or otherwise provided for temporary use within the public space.

### BRIEF DESCRIPTION OF THE DRAWINGS

FIG. 1 shows an outline of the system provided for users within a public space.

FIG. 2 shows details of system implementation options for the system and method.

FIG. 3 shows an architectural overview of a system as described.

FIG. 4 shows an alternative architecture from FIG. 3.

FIG. 5 shows one commercial interaction architecture.

### DETAILED DESCRIPTION

An implementation of the present invention is illustrated in the accompanying drawings. The implementation and its description are only exemplary, and should not be considered limiting. Furthermore, the description should be understood to be primarily logical in nature. That is, the different components or modules of the system are to be distinguished by their function, and may not be actually physically separated in a particular implementation of the system. Similarly, functions of one logical component or module may be divided amongst several physical devices in an implementation.

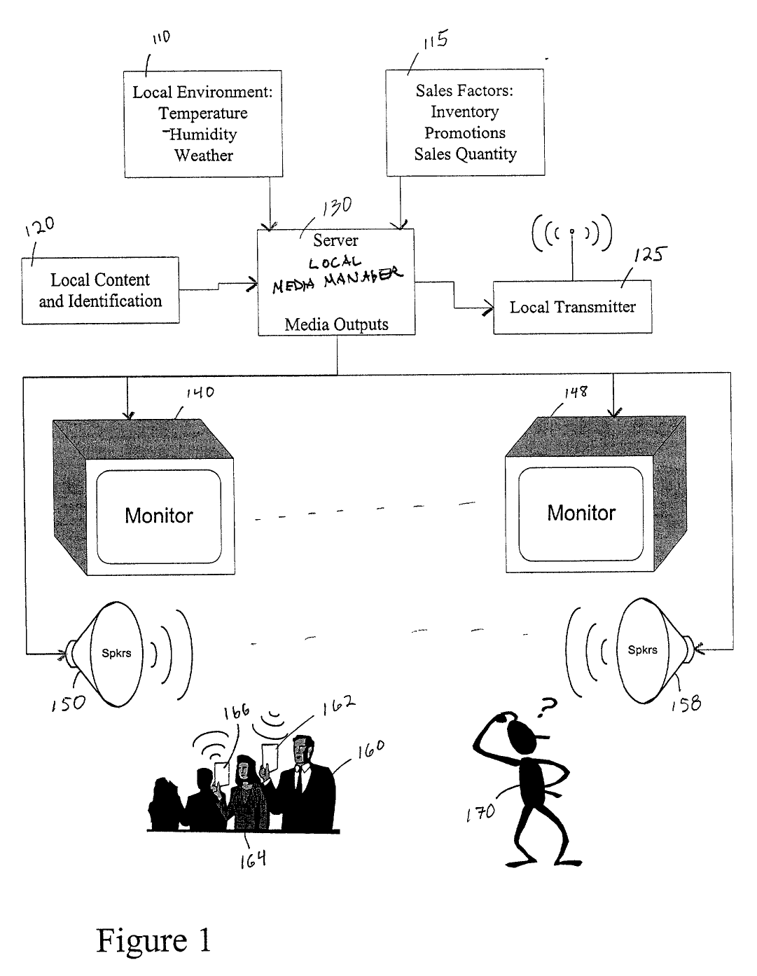

FIG. 1 represents an exemplary public space containing elements of the presently described system. The server 130 performs functions of a Local Media Manager (LMM) within the public space, which may be (for example) a restaurant. The LMM controls the output of media elements to persons generally within the public space (e.g. 160, 164, 170), and may also separately output distinct media elements to personal devices (162, 166) under control of users (160, 164) within the public space. Users, such as 160 and 164, may interact with the system via their personal devices 162, 166 in response to the programming media elements output to the public space generally, or like user 170 may not have such a personal device and not know how to respond to the general programming media element outputs. For those, such as user 170, who do not have their own personal devices, the public space may find it advantageous to lend personal devices. Alternatively, interactive kiosks may be provided at which such a user can interact with the system with respect to the programming media elements output in the public space.

In order to affect the content of media elements, and particularly the selection of media elements for output, the LMM inputs transient state variables which reflect transient conditions of the public space, such as variables reflecting the local environment (110) and variables reflecting local sales factors (115). The local environmental variables may be obtained from direct sensors measuring quantities in the public space such as temperature and humidity, or directly measuring quantities immediately around the public space. The local environment variables may reflect local weather, obtained by direct measurement of sun and wind, or obtained from data services. Transient state variables may also include information about the consumer population in the public space, obtained for example by detectors at the threshold of the public space, or by other techniques such as electronic polling. Indeed, sometimes personal data related to users will be part local transient state variables reflecting the present demographics of the public space. Such demographics change rapidly, and information about the demographics of users in a public space is a valuable variable to track, including raw numbers of people but also more refined demographic data about the population. The sales factors may be obtained from systems, such as Point of Sale systems, which track inventory and sales information. Promotions may be input by download from a remote site, for example via the Internet, or by local control input from a system manager operating the system on behalf of the public space. Local Content and Identification (120) is at some point entered into the system on behalf of the public space.

An important function of the LMM is to coordinate output of related but different media elements to various devices, which typically will have entirely different connection paths to the LMM. For example, the LMM 130 directs programming media elements to a plurality of monitors located, from monitor 1 (140) to monitor N (148), and also to a plurality of speakers 150-158. The programming media elements output to the various monitors need not be the same.

Moreover, the programming media elements output to the speakers may sometimes be related to programming media elements output to the monitors, but often will not be. For example, the monitors might convey silent information, whilst the speakers convey selected audio cuts which the restaurant would like users to buy. The monitors may often be passive, and may be connected to a video source by broadcast or by wired connections, and the speakers as well will often be passive and may obtain their output either by direct wire connection or by wireless broadcast. Thus, the LMM 130 may convey varying and independent programming media elements to a plurality of output devices such as monitors and speakers by a plurality of distinct signal paths, such as video cables for the monitors and twisted pair wires for the speakers. Such programming media elements, sent to output devices (monitors 140-148, speakers 150-158) for general access by users within the public space, is categorized as programming media elements to distinguish it from other categories of media elements. Such general output may include, for example, film clips, songs, or advertising.

Moreover, the LMM 130 is adapted to convey media elements to quite distinct devices, such as personal communications devices 162, 166 controlled by users 160, 164. Such devices may receive, as represented by device 162, but will often be interactive and present an opportunity for the user to transmit requests or other information, as represented by device 166. The media elements output to personal devices will often be of a second category: metadata, which is information related to a different programming media element output in the public space, and/or a third category: local content, which is data relating to the particular public space.

The personal devices such as 162 and 164 may receive data by a variety of signal paths, including wired connections, as discussed in more detail later. However, as represented in FIG. 1, the personal devices will typically be connected via a wireless connection method. In any event, the connection to personal devices will usually be different than the connection to the general output devices 140-148 and 150-158 within the public space. Even if both connections are wireless, the nature of the wireless connection will usually be qualitatively different. For example, a personal digital assistant (PDA) may be connected to a wireless local area network (LAN) via an infrared (IR) connection, while the general output devices receive a local area broadcast completely separate from the wireless LAN.

A particular advantage of the system and method described herein includes coordination or synchronization of related information to a plurality of different devices, and via different signal paths. In a typical example, the LMM 130 will output a programming media element, for example an advertisement for a product, to some of the output devices (140-158) in the public space. At a related time, it will send metadata related to the output programming media element (such as availability and price for the product), plus local content related to the public space (such as an identity of the public space or an order form directed to the public space business), to the local transmitter 125 for conveyance to personal devices 162, 166. A user, e.g. 160, may choose to receive the transmitted media. The transmitted data may provide the user with information about the public space, such as an order form specifying a special deal, which can be employed by the user at a later time to purchase the product at a discount. In that event, the user need not respond to the received information. Alternatively, the transmitted data may facilitate a commercial transaction between the user and a business positioned to make such a transaction (which could be, in our example, the restaurant which is our public space, or could be a separate business contracting with the restaurant for just such commercial transactions initiated by users in the public space). In this case, user 164 will transmit information related to the transaction back to the system via bidirectional personal device 166. Within the system, an order or other interaction may be processed in a local commerce center closely identified with the public space, or the information may be forwarded to a separate but cooperating commerce center.

In order to perform the functions described herein, a system will include one or more of the following apparatus, or an equivalent to such apparatus: a local media manager LMM; a set of passive media output devices in a public space; a set of interactive output devices; transmitters which transmit locally to personal devices; a set of media sources; an array of local sensors and data feeds for transient local information such as temperature, humidity, proximity, inventory counts, and other reports reflecting local or regional conditions; local receivers; and both local and remote controllers to affect the operation of the local media manager. The system may also include interface modules, such as Internet interfaces and associated software, for interacting with commerce centers. Local transmitters and local receivers may operate by any locally directed means, such as local RF, IR, wired or wireless local area networks (LANs), ultrasound, or by broadcasts which are directed locally by range constraints or through coding the broadcast for reception by local devices programmed to accept the coded messages.

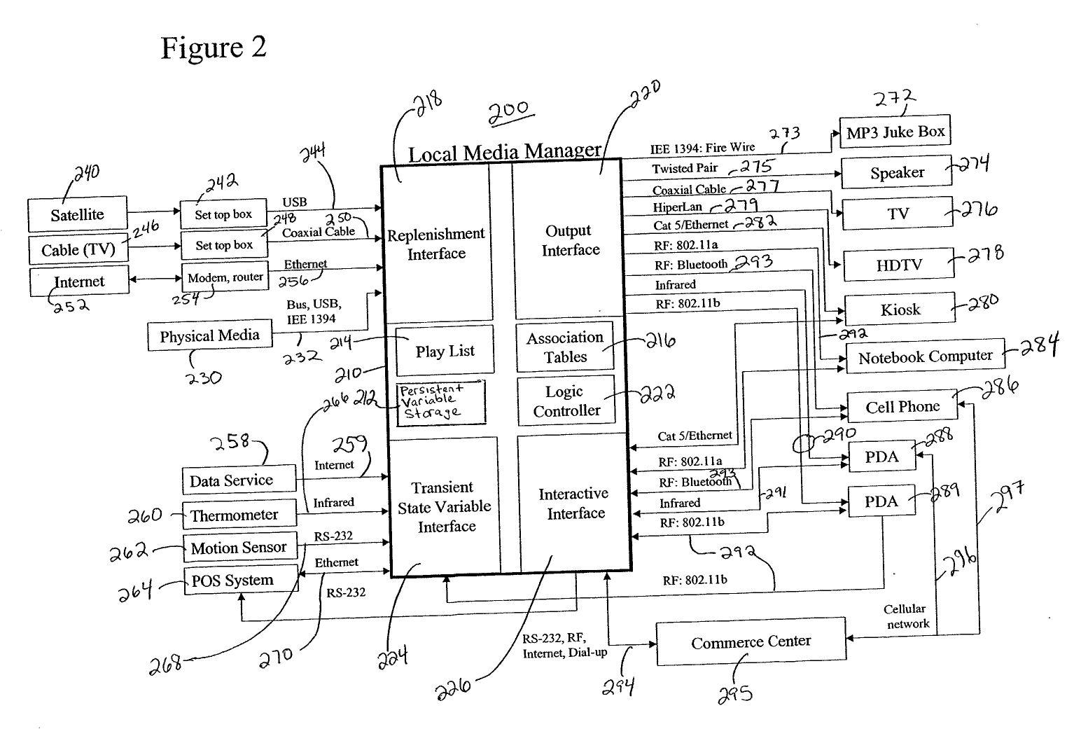

The general operation of the system may be described with respect to FIG. 2 as follows. The LMM 200 maintains an internal state based on a combination of persistent variables 212 and transient state variables (from transient state variable module 224), together with one or more play lists 214 and association tables 216. It receives media elements from various external and internal sources via a replenishment interface module 218, which may obtain media elements from local sources such as storage devices 230 such as DVDs or CDs. The LMM controls which media elements are provided to particular output devices at particular times via an output interface module 220. The combination of media elements which is delivered is determined by a logic controller 222, based on the LMM internal state and the availability of media elements. The output devices associated with a particular LMM are generally situated and intended for perception within a particular public space. However, a particular “public space” may be anything from a single, small tavern to a stadium or an airport terminal. A LMM may also control media output in a public space domain (multiple related public spaces) from a single location.

In addition to controlling the output of media to output devices under its control, the present system also provides for user interaction in public spaces by locally receiving input from users. It this aspect it may provide for electronic commerce (“e-commerce”) in public spaces by locally transmitting information needed to conduct e-commerce to personal devices, where the information may be responded to or enhanced by the consumer, and then communicated to a commerce center for processing. The communication to a commerce center may be directly from a user personal device within the public space, or from the system described herein to the commerce center on the basis of inputs from the user, or from the user but at a different time and location. In the latter case, the user may store information received in the public space regarding media output in the public space which the user heard or observed, may modify this information such as by adding personal information, and may communicate the modified information to the commerce center at a later time, for example after mulling over an offer.

Local Media Manager

The Local Media Manager (LMM) 200 is partly implemented by software running on a server (130 in FIG. 1), such as a PC or RISC workstation, typically located within, or at least near, the public space.

The LMM 218 includes a number of modules, some of which may be implemented as computer programs which communicate with each other via standard inter-task communications protocols such as CORBA and RMI. These modules may include a Replenishment Interface module 218, a Transient State Variable Interface module 224, a Logic Controller module 222, at least one Output Interface module 220, and an Interactive Interface module 226. The computer programs associated with the modules are preferably written in programming languages such as Java or C++ and run under a standard operating system such as Microsoft Windows 2000/NT/95/98, Linux or UNIX. (The functions of these modules are in general not tied to a particular physical device, but may be implemented in other devices and in association with functions nominally attributed to different modules.)

The Replenishment Interface module 218 receives media (such as play lists, persistent variables, system updates etc.) from sources which are often external. Such sources may include a satellite 240, the signal from which may be routed through a receiver/set-top box 242 selectively controlled by the replenishment interface module 218, and then interfaced to the replenishment interface module by any sufficiently high speed interface, such as USB interconnection 244 or a dedicated coax connection. A Cable TV source 246 may similarly be connected via a set top box 248, which will typically be connected to the replenishment interface 218 via a coaxial cable 250. The Internet 252 may also constitute a source of media, and will generally be accessed via a modem or router 254. Many connections to the Internet are presently known, such as dial-up connection/modem, ISDN, DSL, 56 Kb, T-1, cable modem, or the Ethernet connection 256 shown in FIG. 2. The replenishment interface module 218 will generally also have access to physical media 230 provided via a local storage medium, such as CD-ROM, DVD, tape, or diskette, and connected to the LMM by typical computer interfaces 232 such as internal IDE bus, or USB, IEEE 1394 interfaces, etc. These inputs are stored as files on the server. Once a file has been created, or removed/deleted, its entry in the Play List may be modified using a software locking mechanism to prevent incomplete data from being used. The replenishment interface module 218 may also be configured to receive media elements by means of direct connection with an external source, such as a direct video feed.

The Transient State Variable Interface module 224 receives inputs reflecting local conditions. These conditions are distinct from user inputs or choices (except indirectly as will be seen). The transient state variables are received from a variety of sources requiring no regular human intervention. Such sources include local sensors such as the thermometer 260 which is connected to the transient state variable interface module 224 via a wireless infrared connection 266, and the motion sensor 262 which is connected via an RS-232 serial connection. Similar sensors may use any appropriate interface connection, and may measure humidity, sense proximity, count users in the public space, or even measure local weather conditions such as sun and wind. The transient state variable interface may also receive digital data from other processing systems, such as the Point Of Sale (POS) system 264 which is connected via an Ethernet connection 270. The POS system may provide data regarding user purchases and local inventory, which indirectly reflects user choices (such data is not to be confused with willful choices or interactions made by a user, but rather more generally reflects local sales conditions). The transient state variable interface may also receive data regarding local conditions via Internet connection 259 from external data services 258 which provide information such as local weather, local sports and stocks information, and local traffic and transportation information. The transient state variable interface will typically be controlled by the logic controller 222, which may interpret the received data and command when to update the data.

The Logic Controller module 222 reads the persistent variables and the play list provided by the respective modules 212, 214 from either a flat file or a relational database (e.g. Microsoft Access or SQL Server). Based on the persistent variables, attributes from the play list entries, its internal control logic, and generally one or more transient state variables, the logic controller 222 selects appropriate media obtained via the replenishment interface module 218, and directs the output interface module 220 to conduct a process to route the selected media to all appropriate devices.

The media selected by the logic controller module 222 will include programming media elements intended for output to devices to be accessed by many users in the public space, such as large screen TVs, movie screens or other visual output devices, or speakers, radios or such for audio outputs. The media will also include “metadata” elements, defined at the end of this document, which are related to a programming media element. Metadata is most often descriptive of some of the programming media element, complementary to the programming media element, or provides information for obtaining some aspect of the programming media element. The logic controller module 222 will exercise flexible control over a temporal relationship between the output of a programming media element and a corresponding metadata element. The control will be capable of offsetting the timing between these two types of outputs, so that either may lead or lag the other as determined by the logic controller. The system provides a wide range of such temporal offsets, such that the synchronization may be adjusted for a wide variety of purposes. For some purposes, a small offset will be appropriate. More often, temporal adjustments between the two outputs will need to have a control range of at least five seconds, and in other cases at least 10 seconds. Sometimes control of minutes or even hours will be advantageous. This control of the timing of related but distinct media elements may be exerted under logical (automatic) control of transient state variables. For example, it may generally be desirable to provide metadata for a period of ten minutes after a programming media element, such as an advertisement, in order to provide users ample opportunity to order or at least take down information for the later ordering of the product or service. However, if a transient state variable indicates that inventory is low on the item, the metadata output might be cut short. Conversely, if inventory is high and/or sales remain active, it may be useful to output the metadata for a substantially longer period, such as a half hour or more. Thus, the logic controller module 222 may provide very wide-ranging control, not only over what media is output, but particularly over a temporal synchronization between related media.

In some circumstances, it will be convenient to provide information to users within the public space in a manner in which the user may access the information upon request. For example, a user may be employing a web browser type of communication device within the public space. In such circumstances, the synchronization of the output elements may be mediated in part by the user's choices of when to refresh his browser page, even though the media elements are made available to the user at times determined by the system. In this manner, synchronization of the various media elements is still provided by the system.

In the most typical case, the logic controller will direct that programming media elements are directed to passive output devices affixed in the public space. Each of the output transmitters sending signals to the passive output devices are controlled directly or indirectly by the output interface module 220, which typically controls a plurality of such transmitters. Often, the outputs will include the actual media element information in a signal format merely interpreted by a passive device, such as a TV. However, on some occasions it will be useful to output simply instructions, for example via Firewire connection 273, to a separate device containing the actual elements for output, such as MP3 juke box 272. Passive output devices typically receiving programming media elements may include a speaker 274 connected by twisted pair wires 275, a TV connected by coaxial cable 277, an HDTV 278 connected by a high speed HyperLan 279, or an output such as a wide screen monitor in a kiosk 280, which may be connected by an Ethernet local area network (LAN). However, programming media elements may of course be output to devices owned and controlled by users, such as radios or personal televisions. More typically, such user-controlled devices will include notebook computers 284, cellular telephones 286, or personal digital assistants (PDAs) 288 and 289. Such devices may receive unidirectionally, as shown for example by the local area broadcast using the IEEE 802.11a protocol (292) which is received by notebook computer 284. Similarly, PDA 288 may receive a local area broadcast via an infrared broadcast 290. Often, however, communications with such user-controlled devices will be bidirectional. For example, the same PDA 288 may be connected via a bidirectional infrared LAN 291 to interactive interface module 226, and moreover to commerce center 295 via a cellular connection 296. PDA 289 may similarly either receive a locally IR broadcast signal (290). However, PDA 289 is shown representatively connected to the interactive interface module 226 via a local RF connection 292 in accordance with IEEE 802.11b (which may also permit the PDA 289 to interact with transient state variable interface module 224). The cellular connection 296 may be an Internet connection; or, as with cell phone 286, the user may be connected to the commerce center 295 via voice cell network 297. Cell phone 286 may also passively receive a broadcast via the output interface module 220, or actively interact with the LMM 200 interactive interface module 226, via a connection 293. Connection 293 may be a

“Bluetooth” wireless local connection, which conveys data separate from voice communications; or it may be a local cellular telephone connection using a microcellular transmitter within the public space. For completeness, it should be understood that local users engaging in commerce may interact simply with the local media manager 200, which in turn may for some items farther communicate with a distinct, third-party commerce center 295. In such cases it will be advantageous to obtain personal data related to the user, such as name, address and credit card number, or personal data stored in a Palm Pilot™ or other PDA. Of course, commerce center 295 may also be intimately associated with LMM 200, such as to be part and parcel of the same system.

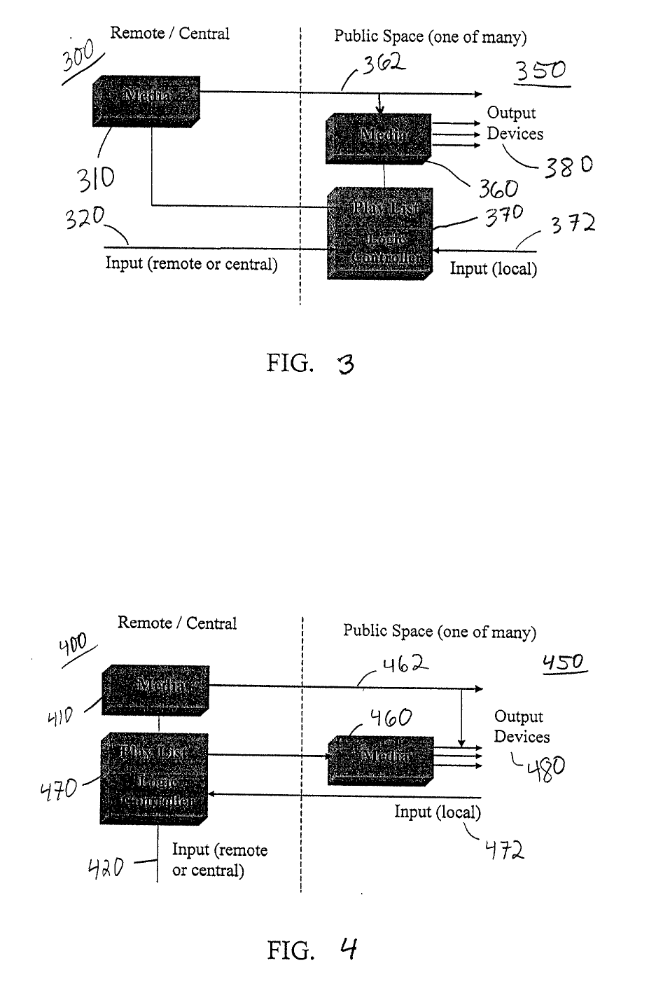

Architectural overviews can be seen in the following figures. In FIG. 3, a remote or central location 300 distinct from a particular public space 350 in which the output devices 380 are located, contains media 310. The media 310 may be in part processed through a local media manager (LMM) 370 local to the public space 350, and may in part be conveyed via path 362 directly into the local public space 350. There, it may be stored in media storage 360, which is also accessed by the LMM 370, before output to output devices 380, but may also go directly to output devices. The LMM 370 may accept control input from a remote or central source 320, and/or from a physically proximate source 372.

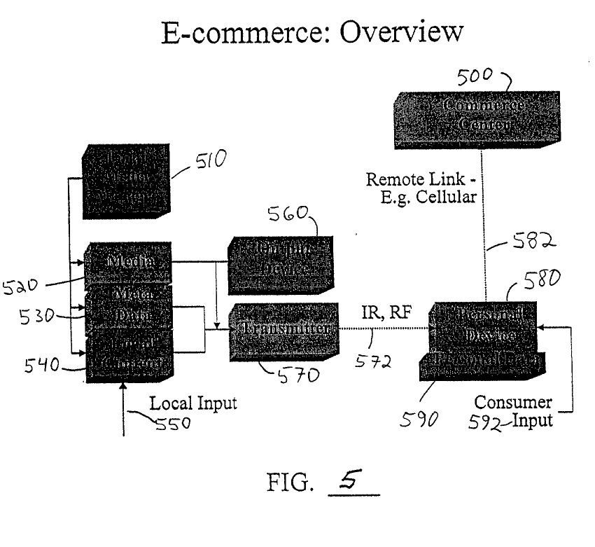

FIG. 4 is a variation of the architecture of FIG. 3. Here, only the output devices 480, some media storage 460, one or more direct media element connections 462, and input 472 are truly local to the local public space 450. The media manager is now a remote media manager 470, which accepts the local input 472 as well as the remote or central input 420. It accesses remote or central media source 410, and outputs via the local (to public space 450) media store 460 into the local output devices 480.

FIG. 5 reveals an architecture of one way to facilitate e-commerce using the system described herein. The only item which is not typically in or by the public place is the e-commerce center, which is somewhere in the Internet ether. Media elements from media storage 520 is directed for output to local passive output devices 560, where it is observed or heard by a user or consumer. The media elements to be output are selected by the local media manager (LMM) 510 at least partly on the basis of locally relevant inputs 550, and stored local content 540. The LMM 510 directs metadata 530, to be combined sometimes with the local content 540, for output by transmitter 570 via a preferably wireless signal path 572, using RF or IF electromagnetic waves to communicate to a personal device 580 in the possession of the very user who has observed the programming media elements output to one of the passive output devices 560. The metadata is related to the programming media elements output to devices 560, though distinct, and may contain purchasing information, special offers, or forms for submission to the commerce center 500 via a link 582. That link may be a cellular telephone connection to the Internet, so some other.

Particular note is made that under one set of circumstances, a user may be expected to perform an e-commerce transaction while within the public space. However, under another set of circumstances, it is desirable that the user initiate some part of the commercial transaction within the public space, if only to store metadata provided about a product, so that the user can complete the transaction later in any of a number of way. For this purpose, it is useful to specially adapt the metadata output to the user, so that it includes information which will, for example, cause the source public space to be recognized as the location where the transaction first began. Moreover, the data needs to be formatted in such a way that the user can very easily retrieve it at later time for sending to a commerce center. It may also be formatted as a printable fax order form, for fax transactions. Such special formatting will enhance the likelihood that a user will later complete the transaction begun in the public space in response to local programming media, and also increase the likelihood that the public space will receive credit for such transaction.

The Interactive Interface module receives input from interactive output devices (i.e. kiosks) and personal devices (web-enabled cell phones, PDAs, notebook computers etc.) via appropriate transmission path (e.g. coaxial cable for Kiosks, wireless - Bluetooth or 802.11x—for PDAs). Based upon logic in the Interactive Interface the inputs are modified, supplemented with additional information (e.g. location information, date and time) and then routed to the appropriate destination (e.g. commerce center, local Point of Sale system) via the appropriate path.

In addition to the modules highlighted above, the Local Media Manager includes one or more play list files, each typically containing multiple entries. An entry in the play list generally includes the name of the file in which the media is stored, one or many attributes which describe the media, and one or many associations which designate associated files containing information relevant to the media file entry.

Attributes of a play list entry describe the media content associated with that entry. These items are typically stored as name-value pairs. For example, a song which is contained in the file designated in a particular play list entry might include the three name-value pairs artist=Beatles, album=Revolver and temperature>75°.

Associations point to locations (or files) where associated information is kept. A typical Association is a location where a purchase-order form (e.g. for the Revolver CD) can be retrieved and transmitted to the user.

Media sources supply media elements such as programming, related metadata, and local content. The sources may be external sources, such as cable television, satellite signal, wide area broadcast, Internet feeds, etc., and/or local sources such as stored video footage, audio tracks, DVD or CD players, tape and video decks, other stored data such as WML, XML or HTML documents, database tables, flat files, etc. Media elements can also include digital forms that consumers can manipulate, enhance, change or interact with, once it is received into a personal device. Examples include digital order forms, spec sheets, price lists, product catalogs, pictures, infomercials etc. that are formatted or structured for personal devices, such as web pages in HTML, WML or XML formats. In many cases, the media would also include the electronic address of a commerce center (URL, phone or fax number, e-mail address etc.). Local content (store name, id, location, local tax rate, etc.) and software needed to perform various functions related to the commercial transaction (e.g. download software, viewers, information/media managers, authorization/verification, routing etc.) would also be included as appropriate. The system can also broadcast or transmit related programming or digital media products (e.g. songs, videos, articles etc.) to personal devices as part of the commerce activity.

The local media manager (LMM) is most readily implemented in a software-based system, and includes the following logical components: play lists, association tables, persistent variables, transient state variables, and control logic. The LMM may incorporate interaction facilitation capabilities, described below. The LMM may, for convenience, incorporate some stored media elements into its local facilities, for example copying a remotely-provided advertising element into local memory. Those skilled in the art will understand that the particular location of such information is a mere bookkeeping matter; as such, locally stored and remotely available media elements will generally not be distinguished in the following discussion, and will be considered to be logically stored within a local media source, even though such element may physically be stored in the LMM. The LMM itself may either be situated directly within or nearby the particular public space for which it directs the output, or it may be located remotely.

Play lists are lists of entries associating external and/or internal media channels or elements to be requested (e.g., from the local store or a remote web-based media service) in conjunction with times and other aspects of current state such as sensor readings to output channels. A play list may simultaneously direct multiple outputs.

For example, the Play List for a certain location might direct, as follows:

At 10:31 a.m.:

output media element #234 to display #1045;

output media element #315 to display #1065;

broadcast media element #10 from IR transceiver #1 (for personal devices);

At 10:35 a.m.:

output media element # 235 to kiosk #1040;

output media element # 645 to display #1065;

broadcast media element #25 from local RF transceiver #10 (for personal devices).

Association tables associate programming media elements to other metadata media elements. One common example would be the association of locally-stored metadata elements (such as artist, album, and/or point-of-purchase information) to songs or other content received from external sources. Another example would be the association of an audio track or MP3 file to a video stream containing a music video. Metadata may also constitute a video clip or other analog information. For example, if an advertisement has an endorsement by a famous sports star, then an appropriate metadata media element would be a clip of highlights of the star's performances.

Persistent variables are stored in permanent or semi-permanent storage (such as a hard disk device) that remains stable over periodic shutdowns or power outages, etc. They may include any amount of information, such as alternative play lists, association tables, and state variable association rules. An example of a state variable association rule is “if temperature sensor value rises above 72 degrees, set weather state to warm.” Persistent variables may be unique to a particular public space, such as geographic location, or they may be unique to a set of public spaces, such as a Zip Code, a state, a premises type (e.g., bar, restaurant, store), or a proprietorship (e.g., “Jeff's Burgers” franchises).

Transient state variables are stored in non-permanent storage and may include data inputs from: measuring devices, such as thermometers, motion/proximity sensors, etc., processing systems, such as point-of-sale, accounting, or inventory systems, and data services, such as traffic reports, stock prices, weather conditions. The data are locally relevant values that can be directly interfaced with the Logic Controller (e.g., digital thermometer via RS 232 port) or manually input (e.g., typing at keypad, voice control, stylus, etc.). The source of the Variables can be local (as in the previous examples) or remote (e.g., via the Internet, modem, etc.—such as local weather conditions from National Weather Center).

The control logic is implemented in software (logic controller) which may be augmented by special-purpose hardware, and acts on the basis of the persistent and transient state variables to determine which media elements available from external or local sources should be sent to which output devices. It is also responsible for making decisions as to which externally-available media elements to cache locally, and as to how and when to replenish the local media source with other externally-available elements. The logic controller may simply follow the directives of a fixed play list, or it may take into account the values of many variables, and direct the caching and subsequent retrieval of multiple media elements. Some examples of logic controller operation are as follows:

If Variable #1 (local temperature) is greater than value #1 (75° F.), then output media element #234 (ice-cold drink commercial); else, output media element #235 (steaming-hot drink commercial).

If Variable #1 (local temperature) is less than value #1 (60° F.) and Variable #2 (local stock of inventory item 24555—men's ski sweaters) is greater than 20, then output media element #555 (commercial for item 24555), media element #444 (Christmas music), and media element #333 (ski videos).

The control logic may also direct alteration of media elements for specific public spaces or domains that are output according to the Play List. For example, text may be superimposed on a video output, or two audio outputs (such as background music and a commentary) may be superimposed.

A Selector Interface module and the Replenishment Interface module may be employed by the local media manager (LMM) for interacting with local media sources. The LMM directs, through the Output Interface module(s), which media elements or combinations of elements are delivered to particular output devices at any given time. The LMM directs, through the Replenishment Interface module, any updating, modification, or replenishment of local media content from remote replenishment sources which is deemed necessary. Part of this functionality may be to implement a local cache of media obtained from remote sources. Remote replenishment sources may consist of any of the same kinds of sources as the remote media sources.

The local and remote controllers may perform all or a subset of the following functions: set persistent or transient state variables, cause replenishment of local media sources, modify, delete, or replace play lists or association tables, and even make alterations in the logic controller itself. The controllers may include a user interface so that a person may effect these changes, or they may be autonomous agents (e.g., programs running on computers).

The output interface(s) is capable of simultaneously directing an arbitrary combination of media elements currently available from the various external and local sources to the various output devices. Each device may receive a different media element than every other device; the output channels and input channels are fully independent.

Input and Output Devices

Output devices may be passive or interactive, and may be connected by wired or wireless connections. Passive media output devices may include video monitors, TVs, audio amplifiers with speakers, etc. Interactive output devices may include personal computer input devices (e.g. mouse, keyboard) at kiosks, touch-screen devices, media players with control buttons, etc. Communication to personal devices such as cell phones, personal desk accessories (PDAs), laptop or palmtop computers, etc., whether via wireless (IR, local RF, wide area RF) or wired (e.g. socket, jack, plug-in connector, cradle) connections, is conducted by “transmitters” controlled by an output module; but it will be understood by those skilled in the transmission arts that the references to transmitters incorporate the associated hardware, including feeds, antennas, amplifiers, etc.

Transmitter modules, incorporating and sometimes loosely referred to as “transmitters” herein, are really “wireless communication interface modules,” and may possess independent decision-making and interactive capabilities. For example, a transmitter may broadcast availability of content “Q”, then listen for requests made by users from their personal devices for content “Q”, and upon receiving such requests, deliver content “Q” directly to the requesting device. This type of interaction is referred to as downloading. Transmitter modules may possess the same interactive capabilities as interactive devices in general, but require a wireless link in the interaction. Other interactive devices access the user in a more direct fashion. For example, a touch screen device may display a description of the available content (which may consist of several options), and upon the touching of a certain position on the screen, will display the corresponding content. No wireless link directly to a user is required for such interactions.

Users may receive locally broadcast (or rebroadcast) media in their personal device by activating the local receive mode of the personal device. Downloading of specific content may be initiated by a variety of input techniques including keyboard, button, touch-screen, stylus, voice, proximity sensor, automatically with software, etc. These same input techniques may be used to enhance received content. For example, one may use a touch-screen to fill out an order form which was downloaded in response to a proximity sensor input. Some functions, such as automatically updating an order form with personal data resident in a personal device, or proactively initiating a download, may employ a software or firmware application which resides on the personal device. Such applications may be preloaded in the personal device, or may be downloaded via local broadcast.

The connection between the local media manager and the various output devices are interfaces appropriate to the delivery of various media. For instance, a TV monitor would be connected via a coaxial cable from a video card or from a device such as a cable box or VCR, whereas the connection to a PC-based kiosk would be via LAN (e.g. Ethernet using Category 5 cable). Transmission to output devices and interactive devices can be via the same or separate paths from those used to transmit to personal devices.

Commerce Interactions

A commerce center may become involved in an interaction by being referenced in a metadata media element. Transmission may take place from a personal device to a commerce center over the Internet, or over any other local or wide-area network (LAN or WAN). Such networks may be interfaced to the personal device via wireless (e.g. IR or local RF) mediums, or physical connections (plug-in, cradle, socket, contact). Examples of wide area mediums include RF/cellular. The same medium may be employed in the reverse direction by the commerce center (e.g. Amazon.com) to transmit back to the personal device (or other location) a confirmation of the order, or to request additional information. However, different communication mediums can also be employed within one transaction or activity. One medium may be used to broadcast or transmit media into the personal device (e.g. IR or local RF) and another to transmit or route information to the commerce center from the personal device (e.g. wide area RF—cellular, wireless phone). Generally, the process starts with initial media being locally broadcast or otherwise communicated to the personal device.

Illustrative examples of some system operations follow, but are not to be construed as an exhaustive list of system capabilities. In particular, user enhancements and subsequent retransmission of the resulting media elements, along with interactive aspects of the system, are addressed elsewhere.

Programming may be transmitted or broadcast to output devices while related programming, metadata and local content are synchronously broadcast to personal devices where they can be received and displayed.

Programming may be transmitted or broadcast to output devices while related programming, metadata and local content are synchronously transmitted to personal devices in response to an interaction by the user (downloaded), and the downloaded information may subsequently be enhanced by the user.

Programming may be transmitted or broadcast to output devices while related programming, metadata and local content are synchronously broadcast to interactive devices (e.g. kiosks and Internet terminals) located within the public space, where the related information can be received and possibly enhanced by the user.

Synchronization

Synchronization refers to related in time, and is not limited to simultaneous transmission or broadcast. Synchronization may include the property of persistence, an ability to keep related programming, metadata and local content available for an extended period before, during or after the output of programming to output devices. For example, metadata or local content related to the previous four or five products advertised could be continuously broadcast locally so that users would have sufficient time to receive product and order information after seeing an advertisement. In a second example, metadata or local content in the form of a list of upcoming songs may be transmitted or broadcast before a programming media element such as a song is played over the speakers (output device), and before a downloadable version of the song is locally broadcast to personal devices. In both of these examples, one or more programming media elements are temporally linked to related programming, metadata or local content in a public space.

The following examples further illustrate typical functionality of the system, thus clarifying some modes of operation of various components.

An advertisement for a toaster (programming) is locally transmitted or broadcast over a wire/cable to a TV (output device) located in a coffee shop (public space), while product information (color choices, specifications, prices, shipping information) structured as web pages (metadata/local content) is simultaneously broadcast via IR to a user's Palm Pilot™ (personal device). Alternatively, the web pages, enhanced with local content, may be transmitted to a kiosk (interactive device).

Movie trailers (programming) are broadcast to televisions (output devices) in fast food restaurants (public spaces), while movie trivia (metadata) and the locations of local theaters and current show times (local content) are simultaneously broadcast via local RF to personal devices.

A promotion for concert tickets (programming) is broadcast over speakers (output device) on a subway (public space) and web pages with order information about the concert (metadata) combined with the location and identification (local content) are broadcast via local RF to personal devices.

A music video (programming) is projected on a movie screen (output device) in a theater (public space) while purchase data and, as appropriate, an MP3 file of the song (related media/metadata) is simultaneously broadcast via local RF to personal devices.

A music video (programming) is projected on a series of TVs (output devices) in a bar (public space) and the song and the complete album are transmitted to a kiosk (interactive device) where they can be downloaded following a purchase transaction. The song is available for a period of time after the music video has changed, but eventually it is replaced with another selection related to what is playing on the screen as will the menu of options displayed on the kiosk (synchronized with persistence).

The following are examples involving electronic commerce.

Both product information and sales order forms structured as web pages (media) are continuously transmitted via local IR within the public space. An order “form” can be for a single product or support numerous products (e.g., electronic shopping cart) and contain address information (phone number and/or URL) on where to electronically transmit the completed order. A consumer decides to ‘receive’ the media into his personal device. The consumer then manually (via stylus input) selects the quantity and color of the products they want, completes the order form with personal data stored in the personal device (i.e. name, mailing address, credit card number) and then transmits the data to a commerce center.

A consumer sees a product advertised on television in a local store (public space) that he or she wants to purchase. The consumer then “receives” product information and an order form (media) that is being broadcast (via local RF) within the public space into his or her Palm Pilot™ (personal device). The consumer reviews the product information in their Palm Pilot™ and completes the order form by selecting the desired color and entering the quantity to be purchased directly into the Palm Pilot™. Personal data (name, credit card, delivery address) is either automatically updated from its common stored location within the personal device, or manually input by the consumer. Either then, or at a later date, the consumer could transmit the completed form via a cellular link to the Internet and on to Amazon.com (commerce center) for processing. The order can be placed from the location where the media was received, or at a later time, from any other location, such as a home, office.

The consumer transfers the modified media at a later point in time, not necessarily within the public space. For example, a consumer downloads media into his or her personal device while in a public space. Then, he or she takes the device home, decides how many widgets to buy, updates the order form/web page, connects the personal device via a hard wired connection to a PC or directly to the Internet (via cable/LAN, or phone modem), and transmits the order to the address included with the media. Similarly, the consumer could download music and related authorization information (media) in a public space via local RF or wired connection (plug-in to network), then leave the public space. Later they can complete the authorization form, transmit it over the Internet, and receive the authorization that enables them to ‘unlock’ or otherwise access the music. Of course the same transaction could take place within the public space.

The following terms are used herein as defined below:

Commerce Center: The location or address where information or content (i.e. order forms, requests for information etc.) involved in e-commerce is sent. Commerce Centers may be web, commerce or mail servers or even fax addresses where orders are manually processed.

Data Services: A service which keeps track of particular information, such as traffic conditions, stock prices, or weather conditions, and provides such information to a service user in a digitally readable format.

Domain: See Public Space Domain.

Download: Individuals download transmitted data onto a personal device subsequent to and as a result of an interaction with the source of transmittal. Generally each download is limited in time and requires its own interactive initiation. Different users downloading within a given public space in general will download different content at the same time, and thus downloading is distinguished from passive receiving in at least this respect.

IR: Infrared wireless.

Local Content: Information (media) uniquely related to or descriptive of a specific public space or domain (e.g., store ID, location/coordinates, date and time at which a local event happens, inventory level, temperature or other local transient state variables, store logo, images of the local community, etc.). Local content can be stored in a public space or transmitted or broadcast from a remote/central location (e.g., regional inventory levels from a central office within a domain.) Local content can also be used as programming media elements or combined with other programming media elements (e.g., an advertisement for a local franchise or a local team logo).

Local Media Manager: A control system to manage output of media elements such as programming media elements, metadata related to such elements, and local content local to a public space or domain. Generally employs software which interprets a play list. The intelligence is nominally located in a logic controller module. May facilitate data delivery and communication to and from users in the public space.

Local RF: Transmission or broadcast in a particular band of the radio frequency spectrum for transmission to local, rather than distant, receive points. Examples are industry standards known as “Blue Tooth”, IEEE 802.11X, Home RF, etc., which are generally restricted to a range a few hundred meters from their source.

Logic Controller: A device configured to use machine logic to change or select from Play Lists based upon conditions (e.g., if condition A is true, then output Media Element # 1; if B is true, then output Media Element #2). Typically implemented as a program running on a computer.

Media: All forms of digital or analog information and content, such as data, text, graphics, video, audio, computer files, software instructions, etc. Classes of media include programming, metadata, and local content.

Media Elements: Discrete ‘elements’ of media, such as individual TV commercials, video clips, songs, sports scores, web pages, etc. May include programming, metadata and local content.

Metadata: Various forms of information and media related to a specific programming media element (e.g., product information, order forms, web pages, video and audio samples or actual products related to programming media elements such as advertisements

Output: Media intended for presentation either directly (e.g., via TV or sound system) or indirectly (via Internet Terminal, Internet Phone, Kiosk, Personal Digital Assistant, etc.) to the public. Output can be either analog (e.g., video or music) or digital.

Output Devices: The physical devices to which media elements are transmitted or broadcast in public spaces including TVs, displays, speakers, movie screens, kiosks, Internet terminals, etc. Local output devices may be passive and generally maintain their presence (typically by being affixed) within the public space. Passive output devices are primarily for playing or displaying media (especially programming) and differ from computing devices where users are able manipulate, enhance, change or interact with, the media within them. Computing devices, bidirectional communication devices, and interactive devices may often function as output devices for some purposes.

Personal Data: Information stored in, or input in a Personal Device such as credit card numbers, name, address, phone number, web address, etc.

Personal Devices: Personal and mobile computing and Internet devices which can communicate via direct-connect (plug-in, contact, or proximity), or wireless media, including Personal Digital Assistants (PDAs, such as Palm Pilot™, Casio E-125, Handspring Viser™, HP Jornado™, etc.), cellular telephones, notebook computers, mobile Internet appliances, etc. Personal devices may be the ‘property’ of the consumer/user and brought into and removed from the premises or, in some cases, may be the property of the public space and retained within.

Personal Device Manager: Software or firmware that enables functions when downloading metadata into a Personal Device.

Play List: At its most basic level, a computer-readable file conveying information about media elements which the Server may output. May include information about when to output the data, and may include (either literally or implicitly), attributes of the media elements to provide bases for a local media manager to select what to output (in accordance with local condition variables) at a given time, and via which medium and path. A Play List may be dynamic, and may be modified, adapted, bypassed or replaced by the local media manager.

Processing System: A system to manage accounting and/or inventory information and to provide such information in digital form, such as a Point of Sale (POS) system.

Programming: Media, often entertainment and advertisements, that is conveyed to output devices. In some cases, personal devices can also receive programming. Programming is typically ‘played’ (video or audio) or ‘displayed’ (text/graphics) and generally differs from computing device media such as data, web pages or software with which users can interact, or which users can manipulate, enhance, or modify.

Public Spaces: Locations other than home or office which are generally accessible to the public, such as stores, restaurants, theaters, stadiums, arenas, public transportation vehicles, etc. Public spaces may include areas in immediate proximity to a defining physical structure, and may also include locations without physical structures, such as beaches, parks, plazas, and parking lots.

Public Space Domain: A group of one or more particular public spaces sharing one or more common attributes (i.e. geography, demographics, size, products or services, brand etc.). Public space domains are comprised of specific public spaces, as opposed to general geographic areas (such as Los Angeles County).

Receive: Individuals may receive broadcast data onto a personal device without necessarily needing to interact with the source of the transmission. Receiving may take place continuously over a period of time. All users that are receiving a broadcast within a given public space generally receive the same content at the same time, as long as reception parameters such as channel or frequency are set identically. Passive receiving of broadcast information is distinguished from active downloading of available information in this respect.

Server: Normally, a computer or workstation and an operating system (e.g., Windows, Windows NT, NetWare, Mac OS, Unix, Linux, Solaris, etc.), but any device or combination of devices capable of directing or directly controlling the output of media, including video recorders, DVD players, tape decks, personal video recorders, etc. A server will often include specialized interface cards/ports for outputting via different mediums (e.g., Ethernet, fiber optic/telecommunication connection, Token Ring, etc.). Such interfaces may employ various protocols, such parallel, serial, or USB connections for computer linkages or DS3, OC3, or DVB-ASI for interface to networks.

User: An individual, usually a consumer, that receives data or programming from, or interacts with, the system within the public space. Generally distinguished from a system manager who controls general operation of the system, for example on behalf of a company owning the public.

Variables: Data inputs from measuring devices, such as thermometers and motion/proximity sensors, from processing systems such as Point-of-Sale (POS) or other accounting and inventory systems, or from data services (defined above).

Wide Area RF: Transmission or broadcast in a particular band of the radio frequency spectrum for transmission to distant, rather than local, receive points. Examples include transmission by microwave or cellular telephony (except innovations such as narrow range microcells), and also wide area RF broadcast such as regional television or radio stations.

What is claimed is:

1. A system for synchronizing delivery of a plurality of media elements to users in a public space, the system comprising:
a replenishment interface module configured to receive media elements;
a logic controller module;
a play list module configured to provide information pertaining to available media elements to be output in the public space;
an output interface module controlling a plurality of transmitters proximate to the public space and configured to output different media elements via different ones of the plurality of transmitters in accordance with instructions from the logic controller;
a storage module configured to store local content specific to the public space and also metadata associated with, but distinct from, a specific programming media element;
wherein the logic controller module is configured to
select which received media elements to output, including a programming media element and a metadata media element associated with but distinct from the programming media element;
direct the programming media element to be transmitted via a first one of the transmitters of the output interface module directly to a programming output device in the public space during a first output period;
direct the metadata related to the programming media element to be transmitted via a second one of the transmitters of the output interface module directly to a metadata receiving device in the public space during a second output period; and
control a variable temporal relationship between the first output period and the second output period.

2. The system of claim 1 wherein the replenishment interface module receives media elements via satellite communications.

3. The system of claim 1 wherein the replenishment interface module receives media elements via a cable TV network.

4. The system of claim 1 wherein the replenishment interface module receives media elements via the Internet.

5. The system of claim 1 wherein the replenishment interface module receives media elements via physical storage media.

6. The system of claim 1 wherein the output interface module is configured to convey the selected programming media element to an output device via a second signal path, and to transmit the synchronized local content via the second transmitter transmitting over a first signal path separate from the second signal path.

7. The system of claim 1 wherein the second transmitter transmits to personal communication devices of users in the public space.

8. The system of claim 8 wherein the second transmitter transmits wirelessly.

9. The system of claim 1 wherein the second transmitter transmits via a local area network.

10. The system of claim 1 wherein the second transmitter transmits via a wireless local area network.

11. The system of claim 1 wherein the second transmitter transmits via electromagnetic waves having a frequency greater than 50 GHz.

12. The system of claim 1 wherein the second transmitter transmits via infrared electromagnetic waves.

13. The system of claim 1 wherein the logic controller module is configured to direct the output interface module to transmit both local content and metadata related to the programming media element via the second transmitter.

14. The system of claim 1 further comprising a transient state variable interface module configured to obtain transient state variable data relevant to the public space, wherein the metadata and the media element are both selected for output at least partly by the transient state variable data relevant to the public space.

15. The system of claim 1 wherein the replenishment interface module receives local content, metadata, and programming media elements via the Internet.

16. The system of claim 1 wherein the replenishment interface module receives local content, metadata, and programming media elements via wireless broadcast.

17. The system of claim 1 wherein the replenishment interface module receives local content, metadata, and programming media elements via wired broadcast.

18. The system of claim 17 wherein the replenishment interface module receives local content, metadata, and programming media elements via cable TV network.

19. The system of claim 1 further comprising a local input module proximate to the public space and configured to accept local content inputs.

20. The system of claim 16 wherein the replenishment interface module receives local content, metadata, and programming media elements from both local and remote sources.

21. The system of claim 16 wherein the transient state variable data relevant to the public space, which partly determines the selected media element, includes data associated with local weather conditions.

22. The system of claim 16 wherein the transient state variable data relevant to the public space, which partly determines the selected media element, includes data reflecting user activity in the public space.

23. The system of claim 16 wherein the transient state variable data relevant to the public space, which partly determines the selected media element, includes data provided by a system processing sales or inventory data.

24. A method of synchronizing delivery in a public space of programming media elements and related metadata, the method comprising:
receiving a programming media element;
conveying the programming media element substantially throughout a programming conveyance time period to a first output device in the public space via a first signal path;
obtaining metadata related to and distinct from the programming media element;
providing the metadata to a second device in the public space via a different second signal path during a data provisioning time period variably and controllably related to the programming conveyance time period.

25. The method of claim 24, further comprising obtaining local content related to the public space, and providing the local content to the second device.

26. The method of claim 24, further comprising providing the local content along with the metadata during the data provisioning time period.

27. The method of claim 24, wherein the data provisioning period begins before the programming conveyance time period begins.

28. The method of claim 24, wherein the data provisioning period persists after the programming conveyance time period ends.

29. The method of claim 24, wherein the second device is a bidirectional communication device controlled by a user who does not control the first output device.

30. A method of synchronizing delivery in a public space of programming media elements and related metadata, the method comprising:
receiving a programming media element;
conveying the programming media element substantially throughout a programming media element conveyance time period to a first output device in the public space via a first signal path;
obtaining local content related to the public space;
providing media elements including the local content to a second device in the public space during a data provisioning time period related to the media conveyance time period.

31. The method of claim 30, wherein the first output device is a passive output device.

32. The method of claim 30, further comprising:
obtaining metadata related to the programming media element; and
providing the metadata to the second device during the data provisioning time period.

33. The method of claim 30, wherein the second device is a personal bidirectional data communications device.

34. The method of claim 30, wherein the data is provided to the second device by a wireless communication device.

35. The method of claim 30, wherein the data provided to the second device is provided by wireless communication to a restricted area substantially limited to within 500 meters of the public space.

36. The method of claim 30, wherein the data provided to the second device is substantially provided only within the public space.

37. The method of claim 30, further comprising:
receiving a response reflecting modification by a user of the provided data.

38. A method of synchronizing delivery in a public space of media elements and related data, the method comprising:
receiving a programming media element;
conveying the programming media element substantially throughout a programming conveyance time period to a first output device in the public space via a first signal path;
obtaining a metadata media element related to the programming media element;
obtaining local content related to the public space;
providing the metadata and local content in the public space during a data provisioning time period related to the programming conveyance time period.

39. The method of claim 38, wherein the metadata and local content are provided by a second signal path different from the first signal path.

40. The method of claim 38, wherein the first output device is a passive output device.

41. The method of claim 38, wherein the metadata and local content are provided to an interactive device.

42. The method of claim 41 further including receiving data supplied by the user from the interactive device.

43. The method of claim 38, wherein providing the metadata and local content is accomplished by broadcasting via a local wireless transmitter.

44. The method of claim 38, wherein providing the metadata and local content is accomplished via a local area network.

45. The method of claim 38, wherein the metadata and local content is substantially provided only within the public space.

46. The method of claim 38, further comprising:
receiving a response reflecting modification by a user of the provided data.

47. The method of claim 38, wherein the media elements and the meta data and local content are transmitted or broadcast to the system via the Internet.

48. The method of claim 38, wherein the media elements and the meta data and local content are transmitted or broadcast to the system via wireless broadcast.

49. The method of claim 38, further comprising:
receiving, independent of user inputs, transient state variable data especially relevant to the public space; and
determining which programming media elements and metadata and local content are provided in the public space at least partly on the basis of the transient variable data.

50. The method of claim 49, wherein the transient state variable data includes data reflecting local environmental conditions.

51. The method of claim 49, wherein the transient state variable data includes data related to user actions in the public space.

52. The method of claim 49, wherein the transient state variable data includes data provided by data services.

53. The method of claim 49, wherein the transient state variable data includes data provided by a system processing sales and inventory data for the public space.

54. The method of claim 53, further comprising modifying a media element at least partly in response to the transient state variable data.
